(19) United States
(12) Patent Application Publication
(10) Pub. No.: US 2004/0033821 A1
(43) Pub. Date: Feb. 19, 2004

(54) In-vehicle entertainment system

(75) Inventors: Christian H. Slesak, Dearborn Heights, MI (US); Yunzhou Guo, Westland, MI (US); Saqib Masood, Canton, MI (US)

Correspondence Address: Raymond J. Vivacqua, BRINKS HOFER GILSON & LIONE, P.O. Box 10395, Chicago, IL, 60610, US

(73) Assignee: Visteon Global Technologies, Inc.

(21) Appl. No.: 10/447,130

(22) Filed: May 28, 2003

Related U.S. Application Data
(60) Provisional application No. 60/403,892, filed on Aug. 16, 2002.

(51) Int. Cl. H04M 1/00

(52) U.S. Cl. 455/575.1; 455/575.9

(57) ABSTRACT

An entertainment system for a vehicle is disclosed. The system includes a storage device, at least one video display device, at least one audio device, and a distribution box. The storage device has entertainment media stored therein. The at least one video display device is used to display the entertainment media stored on the storage device. The at least one audio device is used to broadcast the audio signals stored on the storage device. The distribution box is in communication with the storage device, the at least one video device and the at least one audio device, for routing selected entertainment media from the storage device to at least one of the video device and the audio device.

### CROSS-REFERENCE TO RELATED APPLICATIONS

The present invention claims priority to U.S. Provisional Application Serial No. 60/403,892 filed on Aug. 16, 2003, entitled “IN-VEHICLE ENTERTAINMENT SYSTEM.”

### TECHNICAL FIELD

This invention relates generally to in-vehicle entertainment systems, and more specifically to an improved in-vehicle entertainment system for entertaining multiple vehicle occupants at one time.

### BACKGROUND

In recent years, entertainment systems have become more and more prevalent in vehicles. As technological advances occur the quality of entertainment systems seen in vehicles continues to improve. For example, the first vehicle entertainment systems consisted solely of a small television monitor having poor reception. However, more recently, system shave been introduced having monitors that are larger and capable of providing better reception. In addition, video cassette recorders (VCR), DVD players (DVD), and other entertainment devices were added to the systems.

As a result of the advances in technology briefly discussed above, today's vehicle entertainment systems typically include a large, high-quality monitor equipped with either a VCR or a DVD or both. However, this configuration fails to resolve a common problem that arises when multiple persons simultaneously use the entertainment system. More specifically, this configuration fails to resolve the problem of who gets to decide what program to watch on the sole monitor? Since the inception of television and radio, this has been a problem that has constantly plagued viewers and listeners.

Several attempts have been made to resolve this problem by using, for example, multiple monitors and multiple VCR or DVD players. Although this presented a viable solution to the overall problem, the cost of attaining such a result was prohibitively high. In addition, the systems which included multiple VCR and DVD players consumed a lot of space throughout the vehicles. Further, listening to separate programs required listeners to have separate wire-connected listening devices, such as headphones. This proved to cause discomfort and take up a lot of space within the vehicle.

Therefore, there is strong demand in the automotive industry and other fields for an entertainment system that allows multiple viewers and listeners to comfortably watch and listen to different programs simultaneously without the added cost of adding multiple VCR and/or DVD players to the system.

### SUMMARY

In an aspect of the present invention, an entertainment system for a vehicle is provided. The system includes a storage device, at least one video display device, at least one audio device, and a distribution box. The storage device has entertainment media stored therein. The at least one video display device is used to display the entertainment media stored on the storage device. The at least one audio device is used to broadcast the audio signals stored on the storage device. The distribution box is in communication with the storage device, the at least one video device and the at least one audio device, for routing selected entertainment media from the storage device to at least one of the video device and the audio device.

In another aspect of the present invention, the entertainment system includes a data source having a plurality of entertainment data or media files stored thereon, the data source is in communication with the storage device.

In still another aspect of the present invention, the storage device is a hard drive.

In still another aspect of the present invention, a portable storage device for storing entertainment media stored on a data source is removable from the vehicle.

In still another aspect of the present invention, the storage device stores entertainment media transmitted by a remote data source.

In still another aspect of the present invention, a remote control device for controlling an operation of the entertainment system is provided.

In still another aspect of the present invention, the distribution box further comprises a wireless receiver.

In yet another aspect of the present invention, the distribution box further comprises an audio control board.

In yet another aspect of the present invention, the distribution box further comprise a video control board.

In yet another aspect of the present invention, the distribution box is a portable storage device interface.

These and other aspects and advantages of the present invention will become apparent upon reading the following detailed description of the invention in combination with the accompanying drawings.

### BRIEF DESCRIPTION OF THE FIGURES

FIG. 1 is a vehicle entertainment system including a storage device, a distributor box, multiple video displays, and multiple audio devices, in accordance with the present invention;

FIG. 2a illustrates data sources, such as a wireless server located outside the vehicle, in accordance with the present invention;

FIG. 2b illustrates a flowchart detailing the process by which data is selected and transferred from a data source to a storage device, in accordance with the present invention;

FIG. 3 show a flowchart illustrating system start up, in accordance with the present invention;

FIG. 4, illustrates how the video and audio are paired up so there are multiple filter graph files for each media, each one with a different audio device, in accordance with the present invention;

FIG. 5 illustrates the process by which the filter graph file is constructed, in accordance with the present invention;

FIG. 6 illustrates the process by which the filter graph file is used, in accordance with the present invention;

FIG. 7 illustrates the entertainment system including a remote for controlling the video displays and the audio devices, in accordance with the present invention;

FIG. 8 illustrates process by which the user changes to a different media or powers off the system, in accordance with the present invention;

FIG. 9 is illustrates the category/title screen or system start-up screen, in accordance with the present invention;

FIG. 10 illustrates the process by which a user can navigate through the system start-up screen; in accordance with the present invention;

FIG. 11, illustrates the continue-start screen including a media title box, a continue box, a start box, and a menu box, in accordance with the present invention;

FIG. 12 illustrates the media being played and the playback screen, in accordance with the present invention; and

FIG. 13 illustrates a flowchart showing the process by which the media is played and the process by which the system responds to additional commands, in accordance with the present invention.

### DETAILED DESCRIPTION

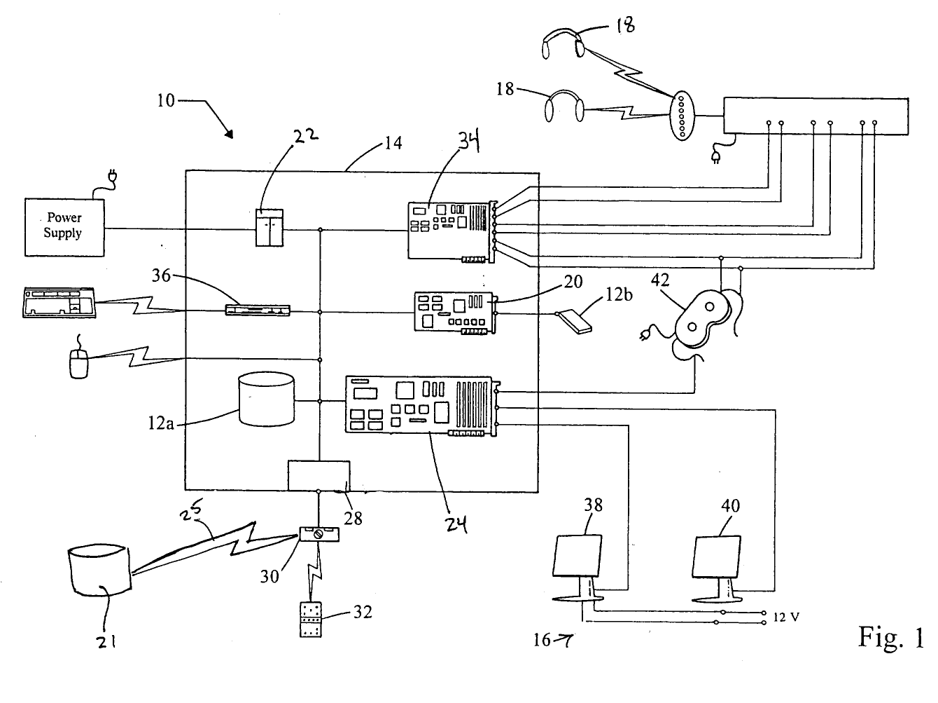

Referring now to FIG. 1, a vehicle entertainment system 10 is illustrated. System 10 includes storage devices 12a and 12b, a distributor box 14, multiple video displays 16, and multiple audio devices 18. Storage devices 12a and 12b may include a fixed hard drive and a removable hard drive or just a removable high-speed external hard drive. In an embodiment, storage device 12b is a high-speed speed portable external hard drive using USB 2.0 technology or other high-speed bus transfer technology. These types of devices are currently manufactured by, among others, Buslink, Fujitsu, Western Digital, and IBM. Alternatively, any other suitable device capable of storing and quickly transferring large amounts of data may be used. For example, other suitable devices may include memory sticks, PDAs, cell phones, and flash memory devices. Further, storage devices 12a and 12b may be of the type having a rotating mechanism or solid-state memory/storage or other mass storage device 12 using present or future technology.

Because storage device 12b is portable, it can be removed from a vehicle and taken to other venues to enable the transferring of files within the car, home, office, etc. For example, storage device 12b may be taken home and connected to a PC (personal computer) and files may be copied from the PC into the storage device 12. Once situated within the vehicle, and connected to distributor box 14, the files stored on storage device 12b would then be accessible by in-vehicle systems coupled to distributor box 14.

For example, video and audio files may be transferred to and stored on storage device 12a. The stored video files are preferably in a DivX format with MPEG-4 compression. The stored audio files are preferably in an mp3 format. However, any suitable format may be used. Other suitable formats include MPG1, MPG2, and WMA.

Storage device 12b is preferably connected to distributor box 14 via a USB cable and interface card 20 running USB 2.0 high speed protocol. This protocol enables storage device 12b to transfer data at a very high rate of speed. For example, storage device 12b, when equipped with USB 2.0 technology, is capable of transferring data at 480 Mbits/second. As an alternative to USB 2.0 protocol, storage device 12b may use other suitable high speed protocols. Moreover, other suitable high speed cables including fiber optics, laser light communications, and firewire may be used, as well.

Entertainment system 10, as discussed briefly above, may also include an external data source 21. The external data source 21 is preferably a server that stores data and transports data to storage device 12a or 12b. Alternatively, any other suitable device capable of storing and transporting data may be used. For example, other suitable devices include the Internet and a LAN.

External data source 21 is preferably connected to storage device 12a via a wireless connection 25. More particularly, data source 21 is preferably connected to storage device 12a via 802.11a wireless protocol. Alternatively, any other suitable wireless connections may be used. Other suitable wireless connections include Bluetooth, 3G, and 802.11b. In some cases, the external data source is connected to the storage device 12b via a hard wire connection. In these cases, the preferable connection is USB 2.0. However, other suitable connections, such as high speed cables (1394 standard, next generation 1394, next generation USB), fiber optics, and laser light communications may be used.

Upon activation by a passenger of the vehicle, data source 21 transmits data to storage device 12b. As discussed above, storage device 12b, in many cases, is portable. In these cases, it is not necessary to have a wireless connection between the external data source and storage device 12b. The storage device 12b could simply be removed from the vehicle and connected to the external data source at the external data source location.

In other embodiments, where storage devices 12a,b are not portable or where it is otherwise beneficial to transfer data to storage device 12a,b while located in the vehicle, data should be transferred from the external data source to storage device 12a via a wireless connection. In these cases, data source 21 would transmit wireless data signals containing data to storage device 12a. The storage device 12a would then store this data until a passenger of the vehicle requests that the data be transmitted in the form of a movie, song, etc.

In order to ensure that data is sent only to authorized and appropriate storage devices 12a, the data transmitted by external the data source is encrypted. Once the data is received by storage device 12, it is decrypted. Any suitable method of encrypting the data may be used. For example, the data may be encrypted before sending out using a Content Scrambling System (CSS). For example, distributor box 14 may receive the data, decrypt the data, and then restores the data to its original format. However, the decryption may be performed after each small packet of data is transferred. The encryption will also include a unique identification tag (ID) to each different distributor box 14, or car, or disk, etc. So when multiple entertainment systems are located at the same place, such as a gas station or a hotel, the data can be sent to the correct individual. The whole process will be more like a secured FTP session.

In addition, external data source 21 contains security levels to prevent unauthorized copying and distribution of content or data. The security levels used in the data source are preferably similar to security levels used in DVD technology. Alternatively, any suitable security level may be used, such as regional protection, hardware protection, or software protection. In these cases, for example, the content can only be played back through a special software application, or a particular hardware.

The storage device 12b may communicate with data source 21 that may be a LAN, a WAN, the Internet, etc. Generally, storage device 12b receives data from data source 21 and, subsequently, transfers the data to distributor box 14. The data source 21 may be connected to the storage device 12b via high speed transfer cables. In this case, the data source is a server and the storage device 12b is connected to the server via USB 2.0 and the data is transferred thereafter. After data transfer, storage device 12b is removed from the server and placed inside the vehicle's center console, for example, and connected to distributor box 14. Alternatively, data source 21 may be a server connected to storage device 12b via high speed wireless protocols. In this case, the data is stored on the server, which is located in close proximity to the vehicle, such as 100 feet or less from the vehicle, and is transferred wirelessly via an 802.11a protocol. This can be initiated via a custom made touch screen software located either inside the vehicle or at the server location itself. Each of the options discussed above enable a user to retrieve media files from the storage device 12b.

The storage device 12b is preferably located within a passenger compartment of the vehicle. More particularly, the storage device 12b is preferably located in a center stack of the vehicle. Alternatively, the storage device 12b may be located in any suitable location capable of being accessed by passengers of the vehicle, as described below. For example, other suitable locations may include an instrument panel, a center console, a second row storage pod, an area under a seat, and an overhead console.

The distributor box 14, in an embodiment of the present invention, includes a CPU 22 (Intel P4 2.2 GHz is preferred), storage device 12a which is a hard disk with Windows XP installed (the hard disk is also the host of the server and system player software), GeForce440 AGP video card 24 for one screen, one PCI colorgraphic predator media pro video card (not shown) for two more screens, a PCI USB 2.0 converter 20 which connects to the portable disk or storage device 12b, a wireless card for networking with a wireless server, a motherboard 26 with two serial ports (for Infrared receivers), two USB 1.1 ports which connect two USB audio devices, and one onboard audio output.

CPU 22 provides the power to do software decoding without jeopardizing the server and player software. The hard disk contains the OS, server and player software, and also provides space for receiving wireless and other data. Video card 24 provides at least three screen outputs, the onboard sound and two USB audio devices are the audio portion of the video-audio pair. A serial port 28 connects to an IR receiver 30 which receives signals from a remote 32. The PCI USB 2.0 converter 20 is the interface to portable storage device 12b. The wireless card provides a continuous and valid local area network with a wireless server.

The distributor box 14 can play multiple types of media files, including but not limited to MPG1, MPG2, mp3, WMA and DivX. DivX is a new video format with MPEG-4 compression. The decompression process can be achieved through either software decode (“DivX Codec”), or from hardware decode. Right now, there is only few hardware decoders available on the market so the software decode scheme is used.

The multiple outputs are achieved with multiple video paired with individual sound devices, one onboard sound, and two USB audios through USB outputs, or sound cards 34 such as Delta410 from MidiMan (a PCI card that has 4 inputs and 10 outputs, however, it shows as separated sound devices in the OS). The multiple video output can be achieved through a multiple video card, or single video cards that have multiple outputs (such as Geforce 440, Colorgraphic Predator Pro series cards).

The distributor box 14 is the part of system 10 that does all of the computations and calculations required in the process of transporting media from the storage device 12b to the video displays and/or audio devices. The distributor box 14, preferably, includes a CPU 22, a hard disk 12a, an audio/video subsystem 24, 34, and an IR receiver 30. The CPU 22 is preferably a P4 2.2 GHz. Alternatively, any other suitable CPU may be used. The hard disk is preferably equipped with Windows XP. Alternatively, any other suitable operating system may be used. In addition, the hard disk is, preferably, the host of server and player software.

The audio subsystem 34, preferably, includes a single audio card with multiple outputs. More specifically, the audio subsystem 34, preferably, includes an audio card having multiple inputs and outputs. As noted above, audio files are stored in the storage device 12 and transferred to the audio devices in an mp3 format. The audio subsystem 34 converts the files from mp3 into a format that may be listened to by passengers. Alternatively, the audio devices read and convert the mp3 files into a format that may be listened to by passengers. Thus, any suitable device or combination of devices capable of converting compressed audio files into multiple audio signals may be used.

The video subsystem 24, preferably, includes two video cards, an AGP and a PCI. More particularly, the video subsystem 24, preferably, includes a GeForce440 AGP video card and a PCI colorgraphic predator media pro video card. Alternatively, any one or more video cards capable of producing multiple video signals may be used. For example, a single video card having multiple outputs, such as a Matrox (AGP or PCI), which has four outputs may be used.

As discussed above, the video files are stored in the storage device 12b and transferred from the storage device 12b to the distributor box 14 in a compressed format, such as DivX. Therefore, the video files must be decompressed by the video subsystem 24 before being output to the video displays. The video subsystem 24 preferably relies on software decoding to decompress the video files. More particularly, DivX Codec is, preferably, used to decompress the video files. Alternatively, hardware decoding may be used to decompress the video files. In addition to decompressing the video files, the video subsystem 24 uses software to divide the mass amounts of data transferred from the storage device 12 to the distributor box 14 in order to transfer designated files to the video displays.

The receiver 30 is preferably a conventional receiver. However, any device capable of receiving signals from remote 32 may be used. The receiver 30 is preferably connected to remote 32 via a wireless RF connection. As the remote 32 is activated by a user, signals are transmitted from remote 32 to receiver 30. The signals transmitted by remote 32 are received by receiver 30 and transmitted to distributor box 14 where they are interpreted.

The multiple video displays 16 are preferably LCD displays. More particularly, the displays 16 are preferably 8-inch, TFT, LCD, 16×9 aspect ratio Toshiba display or the like. Displays 16 are preferably located within an overhead compartment of the vehicle. In a preferred embodiment, displays 16 fold down and, therefore, become visible to passengers within the vehicle upon being activated. Alternatively, any suitable location capable of making displays 16 visible to a passenger within the vehicle may be used.

In other embodiments, at least one of displays 16 is preferably a head mounted display. More specifically, the display is, preferably, an Olympus 250 wide screen model, or the like, which allows for multi zones. The head mounted display is especially beneficial in smaller vehicles where interior room tends to be scarce and in front seats of vehicles where displays visible to a driver may be prohibited by law.

In addition to those displays discussed above, any suitable display capable of visually transmitting signals to a viewer may be used. Other suitable displays include OLCDs and face mounted displays 42.

The video displays 38, 40, 42 are connected to distributor box 14. The video displays 38, 40, 42 are, preferably, connected to distributor box 14 via cable connections. Alternatively, other suitable connections capable of transmitting video signals from the distributor box 14 to the video displays 38, 40, 42 may be used. For example, wireless connections, such as RF and IR, may be used. After a passenger selects a certain program to watch, as discussed in more detail below, a signal is transmitted from distributor box 14 to the intended video display. The display receives the signal and, as described below, converts that signal into a visual image for the passenger to view.

In alternative embodiments, video displays 16, rather than the distributor box 14, are equipped with a directional IR receiver. Thus, remote 32 that could contain an IR transmitter would need only be pointed at the intended display to control-that particular display. The IR signals transmitted from the remote 32 are focused in a beam such that remote 32 is only capable of controlling the screen at which it is pointed.

The audio devices are preferably wireless headphones 18. In some cases, the video display and the audio device are combined. For example, the head mounted video display, in alternative embodiments, includes a set of wireless headphones.

The headphones 18 are connected to distributor box 14. More specifically, the headphones 18 are preferably connected to the distributor box 14 via a wireless connection, such as IR or RF. Alternatively, other wireless or wired connections are suitable and may be used. In many cases, the audio device includes an IR receiver while the distributor box 14 includes an IR transmitter. Upon being activated by the remote 32, as discussed more fully below, the distributor box 14 transmits IR signals via its IR transmitter. These signals are received by the IR receiver of the audio device and the audio device converts these signals into audio signals to which a passenger may listen.

The wireless headphones 18 preferably receive a multiplexed signal containing multiple frequencies. The wireless headphones 18 are preferably multi-channel wireless headphones. A suitable example of such headphones is the 4 channel White Fire headphones offered by Unwired of Farmingdale, N.Y. A signal having multiple frequencies corresponding to the headphone frequencies are transmitted from the distributor box 14 to the headphones 18. Each headphone is capable of decoding the multiplexed signal. Because each signal includes multiple frequencies and each headphone is configured to receive only a particularly frequency, the signal intended to be received by one set of headphones does not disrupt or interfere with the signal received by another set of headphones.

As an alternative to wireless headphones 18, any suitable audio device capable of transmitting audio signals to a passenger within the vehicle without substantially disrupting other passengers may be used. In some cases, as an alternative to wireless headphones, audio speakers are built into headrests within the vehicle. The headrest speakers may be connected to distributor box 14 in any suitable manner. Thus, signals are transmitted from distributor box 14 to various headrest-speakers throughout the vehicle. The headrest speakers then convert the transmitted signals into sound to which the user may listen.

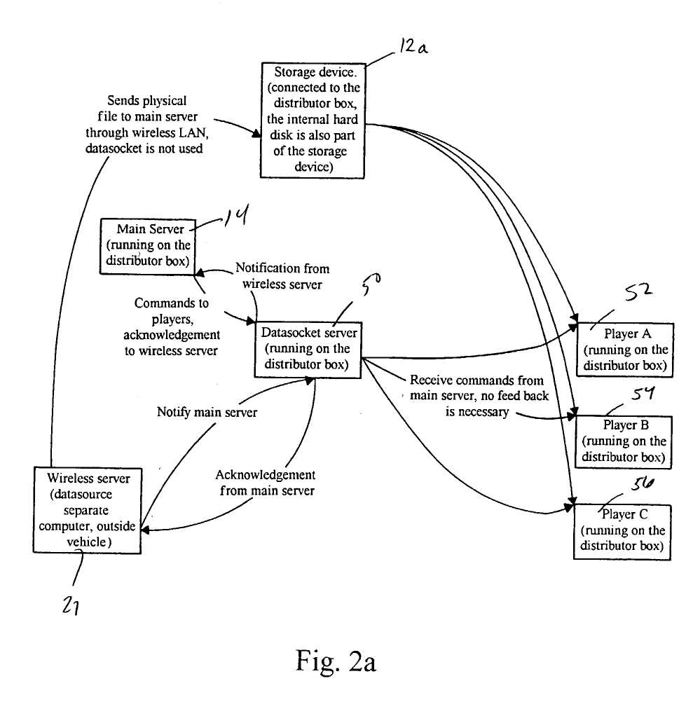

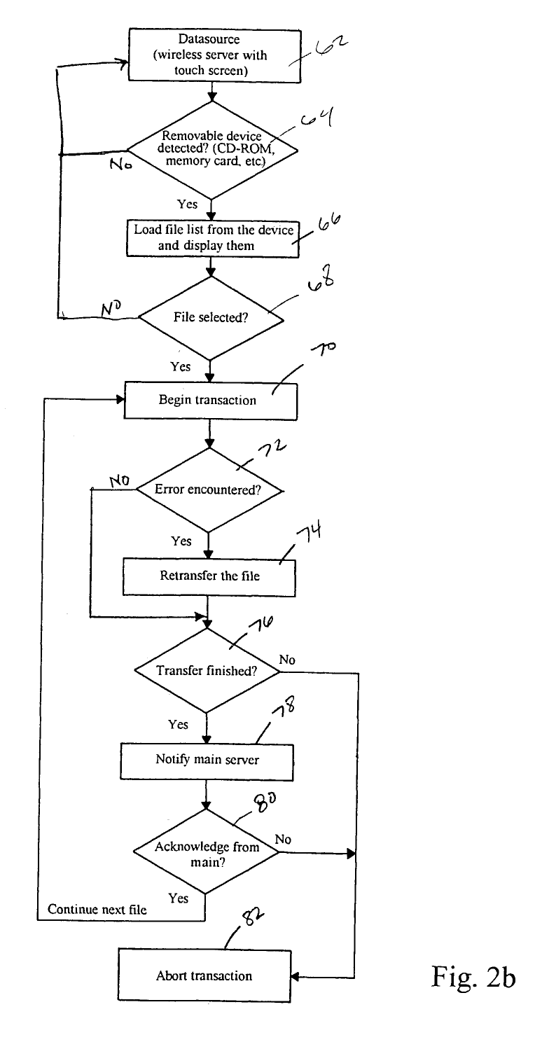

A functional flow chart describing data signal transmission between system components such as storage device 12b and the distributor box 14 and data sources, such as a wireless server located outside the vehicle is illustrated in FIG. 2a. Generally, wireless server or a data source 21 will notify a main server running on the distributor box 14 that data source 21 is ready to send entertainment media to storage device 12a. A data socket server 50 running on distributor box 14 receives commands from the main server or a wireless server. The media players 52, 54, and 56 receive commands and entertainment media transferred from data source 21 to storage device 12a from the data socket server. FIG. 2b is a flow chart detailing the process by which data is selected and transferred from a data source to a storage device. At block 62 and 64, data source 21 determines whether a removable device has been detected. If a removable device such as CD ROM or memory card has not been detected, then the data source will continue to monitor for such a device. However, if removable device has been stacked at block 66 a file list is loaded from the device and displayed. If the user, at block 68 has selected a file from the file list to transfer from the data source to the storage device, then the transaction or transfer begins as indicated by blocks 68 and 70. If the file has not been selected, then the system returns to the file list at block 62. At block 72, the system checks for errors. If an error has occurred then the file is retransferred as indicated at block 74. If no errors are detected the file continues to be transferred at block 76 and the system determines whether the transfer is finished. If the transfer is finished then at block 78, the main server running on distributor box 14 is notified. If it is determined that the main server has acknowledge the notification from the data source at block 80, then the process returns to block 70 where the next file from the file list starts to be transferred to the storage device. However, if no acknowledgment is received from the main server, then the transfer or the transaction is avoided, as represented by block 82.

FIG. 3 is a flow chart illustrating system start up. Once the distributor box or computer 14 is activated, as represented by block 90, data socket server 94 and main server 92 are initiated. Thereafter, as represented by block 96, the media players are loaded. The player for each of the display screen 38, 40 will appear on each of the screens. At block 98, the main server monitors any remote signals and data socket elements for transmit commands. If no signals are detected at block 100 then at block 98 remote signals and data socket elements continue to be monitored for transmit commands. However, if a signal is received as determined by block 100, the commands are parsed as represented by block 102 and translated into a readable command, i.e. play, stop, etc. Main server then sends both the parsed command and the player that sent this command to the data socket, as represented by block 104. At block 106, the system determines whether the commands are from the wireless server. If no commands are detected from the wireless server then at block 110 the stop button is monitored. If the commands are from the wireless server, at block 108, a filter graph is created and one of the entertainment players is notified. At block 110, if the stop button on the remote has been held down for more than five seconds, then the system menu shows up to allow the user to either change the disk or power off the system, as represented by blocks 110 and 112. At block 114, a power off command is detected if the power off command is received from the remote, the server sends a command to shut down the system, as represented by block 116.

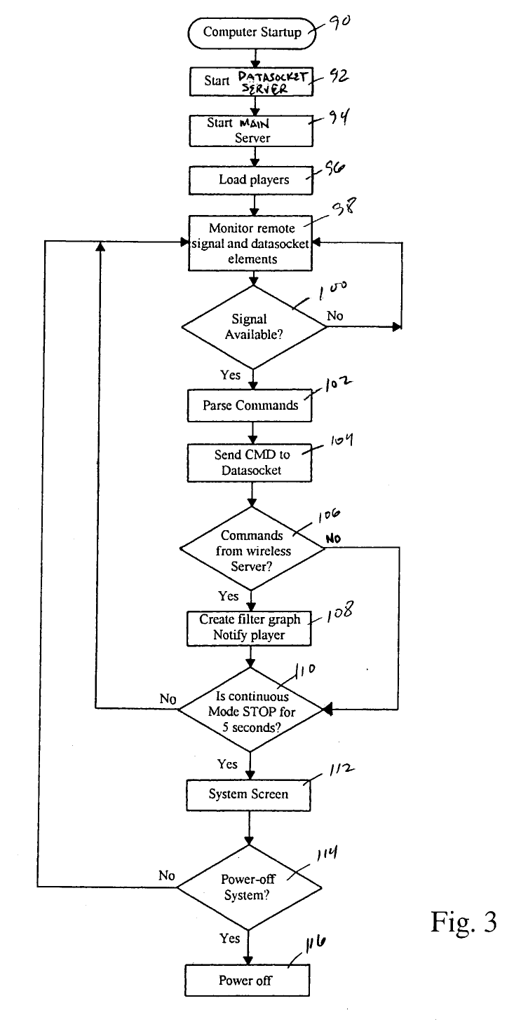

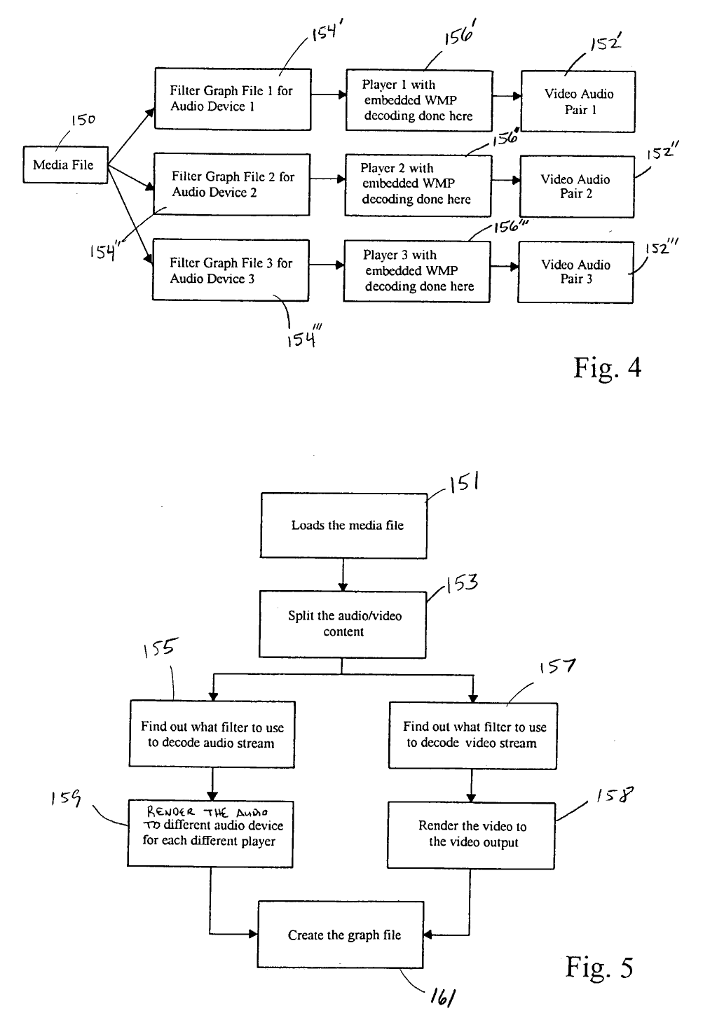

With reference to FIG. 4, when a media file 150 (a video or audio file) is ready to be played for a particular pair of video/audio outputs 152′, 152″, 152′″, a filter graph file 154′, 154″, 154′″, created previously, is loaded into system 10. In order to allow multiple files to be heard and/or viewed simultaneously on different video displays and audio devices, the files are loaded separately into the distributor box 14. The filter graph file is actually a simple file that contains filters that are necessary for a DirectShow application, such as embedded Windows Media Player (WMP), to playback media file 150 to a particular audio (or video) device 156′, 156″, 156′″.

Server and player software are connected through a technology called Datasocket. When the server starts up it loads the datasocket server and then the player software. As the datasocket is running, variables or sockets are created and reserved for the communication from the server to the player software. The server software monitors the IR receiver parses the incoming signals and translates them to the commands understood by the player software, then it sends the command to a socket on the socket server. The player then acts upon seeing the changes of that socket. There are several sockets used in this application.

The media files are transferred via the Data Source to the Storage device 12. The software also automatically completes the graph filter files that separate the audio and video streams from the media file. The graph filter files are now available to be loaded by the media players 52, 54, 56.

The filter graph tells the DirectShow application (in this case, the embedded windows media player) what filters to use for decoding video and audio streams, it also tells the application what audio device to use. For example, with a DivX video file (DivX is a MPEG4 compression), the video is loaded, then for every frame in the video the video and audio streams are separated, video is then decompressed through software decoding (hardware decoding may also be used) and sent to the screen. Audio screen is also decoded (the audio is in MP3 format) and then sent to a specified audio device. Therefore, if there are three filter graphs, each one uses a different audio device, then when three players load these three filter graphs, the videos are on their own screens and with different audios.

FIG. 5 illustrates the process by which the filter graph file is constructed. At block 151, a media file is loaded. The audio and video content of the media file is split at block 153. At block 155, a determination as to the appropriate filter to use to decode the audio stream is made. At block 157, a determination as to the appropriate filter to use to decode the video stream is made. A different audio device is used for each different player, as represented by block 159. At block 158, the video is rendered to the video output device. The graph file is created, at block 161, the filters used to construct the graph are saved for later use.

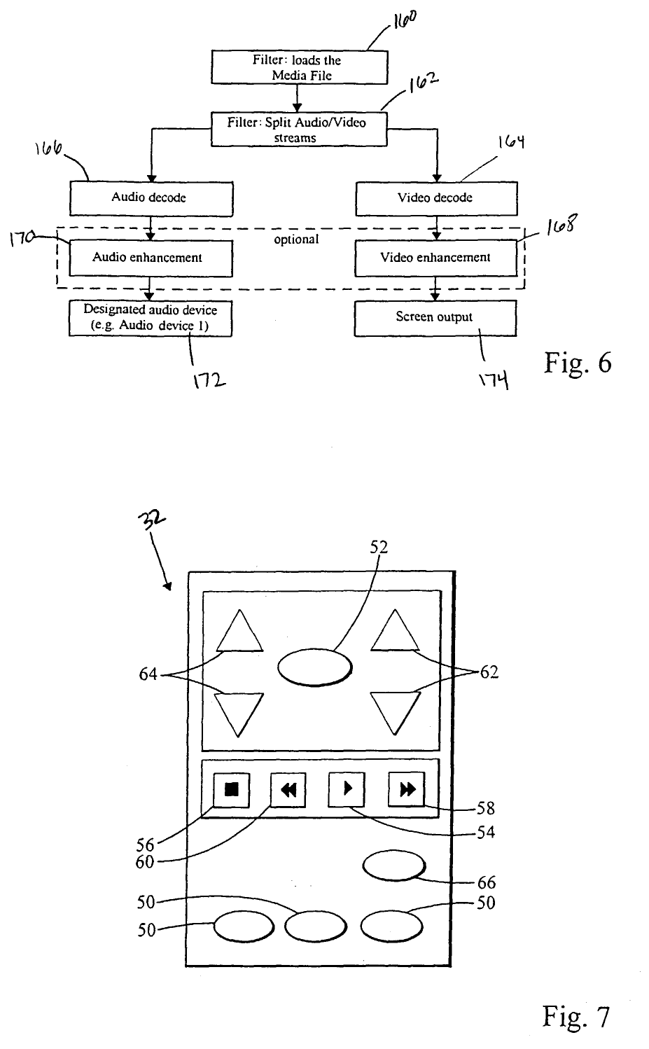

Referring now to FIG. 6, a flowchart illustrates the process by which the filter graph file is used is shown. Media file 150 is loaded frame by frame into memory, at block 160. At block 162, the media file 150 is split into two streams, a video stream and an audio stream, as represented by blocks 164, 166. An optional audio/video enhancement step 168, 170 may be undertaken before sending the audio/video streams to the audio/video devices. Thereafter, the video stream is routed to the video device 174 (or screen) and the audio stream is routed to the audio device 172 specified in filter graph file 154′, 154″, 154′″. Since the video and audio are paired up so there are multiple filter graph files for each media, each one with a different audio device, as shown in FIG. 4.

As noted above and illustrated in FIG. 7, the entertainment system 10 preferably includes a remote 32 for controlling the video displays and the audio devices. The remote 32 is preferably a conventional remote. Alternatively, any suitable device capable of transmitting command signals in multiple different codes to the distributor box 14 and, in some cases, the video display may be used. Other suitable devices, for example, may include a plurality of remotes or a PDA. Further, distributor box 14 may be equipped with voice recognition software such that the voices of passengers may act as the remote. The remote 32 is preferably connected to the video displays and audio devices via a wireless connection, such as an IR connection. However, any suitable connection may be used.

Referring to FIG. 7, remote 32 includes various buttons which correspond with various system commands. These buttons include screen (A, B, C, etc.) buttons 50, a select button 52, a play/pause button 54, a stop button 56, a fast-forward button 58, a rewind button 60, a channel (±) button 62, and a volume (±) button 64. The screen buttons 50 serve to activate remote 32 to control the video display and audio device corresponding to the particular screen button that is pressed. For example, pressing screen button “B” would activate video display “B” and audio device “B.” Once one particular video display 16 and audio device 18 has been selected, the other buttons on the remote 32 may be used to alter the audio and video characteristics of that particular video display and audio device, respectively. A mode button 66 is provided that activates the system screen (system menu). The system screen is activated by holding down the mode button and pressing another button such as the play button. From the system screen, system control settings such as shut down system and connect to a portable device may be selected.

As discussed above, the remote 32 may include an IR transmitter that interacts with an IR receiver located on the video displays. By pointing the remote 32 at a particular display, the user would be activating that display. Thus, this configuration could be used instead of the screen buttons on the remote 32.

The channel (±) buttons 62 serves to move a highlighted box up and down throughout the different categories displayed on the screen, as shown in FIG. 9. Once a title on the screen is highlighted, the media corresponding to that title may be played by pressing select button 52. If the media has a recorded position at which it was previously stopped, the Continue-Start screen appears. This gives the user a choice to continue playing the media where it had previously been stopped.

The volume (±) buttons 64 serve to increase and decrease the volume of the audio device corresponding to the remote 32.

The play button 54 functions to play the media where the media is stopped or paused, and it functions to pause the media where the media is playing.

The stop button 56 serves to stop the media where the media is playing. Further, if the mode button 66 is selected first, then holding down the stop button 57 for 5 seconds causes a system menu to appear on one of the screens. This gives the user the option of powering the system 10 off or changing the storage device 12.

The fast-forward and rewind buttons 58, 60 function to advance ahead and backtrack, respectively, in the media while the media is playing. Additionally, these buttons enable a user to scroll through various buttons appearing on the display screen, such as title list, back button, and main button.

The mode button 66 serves a purpose similar to that of a function key. By pressing the mode button 66, all other buttons on the remote 32 may take on a different role. In particular, when the mode button 66 is pressed and then the stop button 56 is held down for five seconds, this serves to display the system screen. Similarly, when the mode button 66 is pressed and then the stop button 56 is pressed, this enables a user to change the storage device 12.

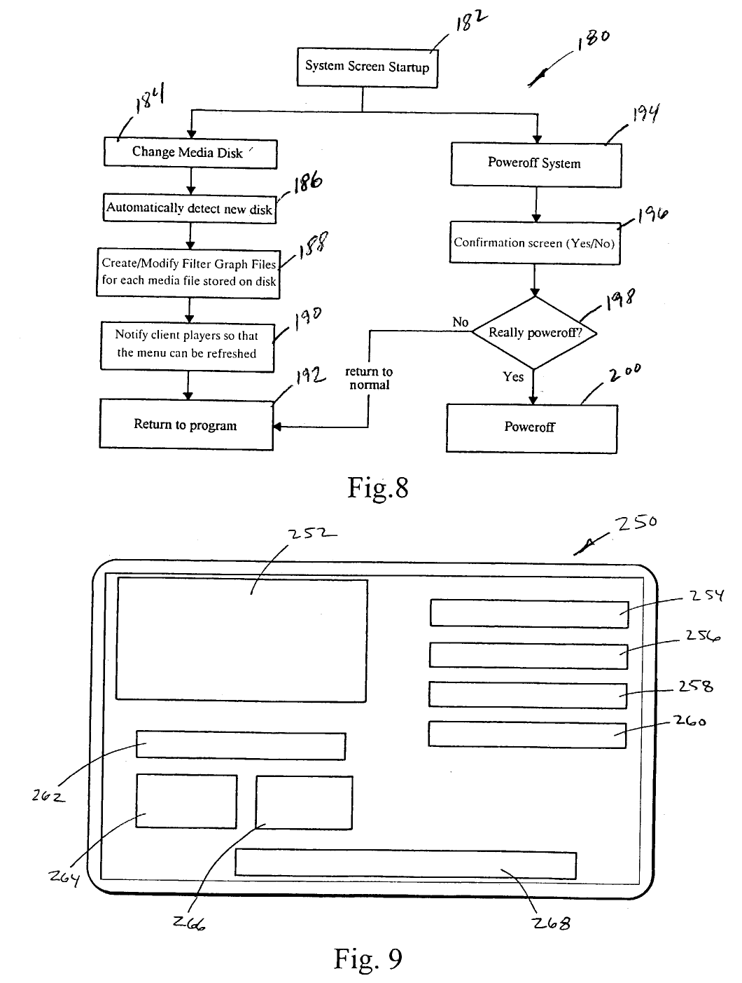

A process 180 by which a user changes to a different media or powers off the system is illustrated in FIG. 8. Process 180 is initiated at block 182 at which a system user enters a system start up screen. The system user may select from one of two options: 1) change a media disk, at block 184 or 2) power-off the system, at block 194. If the system user decides to change a media disk, at block 186 a disk is automatically detected. At block 188, the filter graph files are created/modified for each media file stored on disk. Each client player is notified so that the menu may be refreshed, as represented by block 190. At block 192, the user is returned to the system screen. However, if the system user decides to power-off the system, at block 196 a confirmation screen is displayed. At block 198, a determination of whether the system is to be powered down is made. If it is determined that the system is not to be powered down then the user is returned to the system screen, as represented by block 192. If, however, it is determined that the system is to be powered down then the system powers off, as represented by block 200.

Files may be copied to the storage device 12 in many different ways. As discussed above, the storage device 12 may be removed from the vehicle, then connected to a PC, then files may be transferred from the PC to the storage device 12. Likewise, the storage device 12 may be connected to a PDA or any other suitable device capable of transferring files to the storage device 12.

Files may be transferred from the data source to the storage device 12 as noted above and shown in FIGS. 2a and 2b. The data source may include a touch screen interface in which a user can point to the desired data/content and wirelessly transfer the data to distributor box 14. This interface is designed for ease of user interaction.

The touch screen is located inside or outside the vehicle. It can be any place that is under the same wireless network coverage as the distributor box 14.

Right now the data from the wireless server to the distributor box 14 is a simple file copy. First, the file on the wireless server is opened, then a small chunk is read, this amount of data is sent to distributor box 14 and is stored on the hard disk (but could also be on the portable storage device 12b). Each transferring is accompanied with a simple error check, if error occurred then that packet is resent, if multiple re-try failed then a failed message is displayed on the touch screen. After distributor box 14 receives the complete file, three filter graph are created to be ready for the player to use.

An enhanced feature of system 10 is the ability to connect storage device 12b to the data source. With the wireless or wired strategy data/content can be moved from the data source via flash memory, memory stick, CD-R, CD-RW, etc. over wires or wireless application to the storage device 12. This allows the data/content that is being used by all universal storage devices to act as the server. Because of this universal plug and play feature the ability for end customers to use it with the variety of storage devices today shows the universal adaptability of distributor box 14 to be used with any device on the market now and in the future.

With the emerging popularity and large storage space of flash memory, personal CD-R/W, it is possible that a user would want to put whatever video and audio files stored on this media onto distributor box 14 so they can enjoy it in their vehicles. The application reads the contents on these media and displays a list to the user. The user then selects what he/she wants, with a single click or finger touch these files are be transferred to distributor box 14 or the portable storage device 12b. This demonstrates that the data source is not limited to the Internet or LAN, but may also result from the users' own data storing devices.

Once files have been transferred to storage device 12a, a passenger of the vehicle may command distributor box 14 to retrieve a particular file from the storage device 12 and transfer it to the video display and/or audio device depending on the file requested. FIG. 9 is an illustration of a category/title screen or player start-up screen 250. Player screen 250 includes a picture area portion 252 for displaying a picture of a media title. Further, a plurality of category selection areas 254, 256, 258, and 260 are provided for selecting various categories. A status area 262 is also provided on screen 250 for indicating a status to the system user. A main button 264 and back button 266 allow the system user to navigate through available media files. Disclaimer portion 268 provides an area to communicate a disclaimer to the system user.

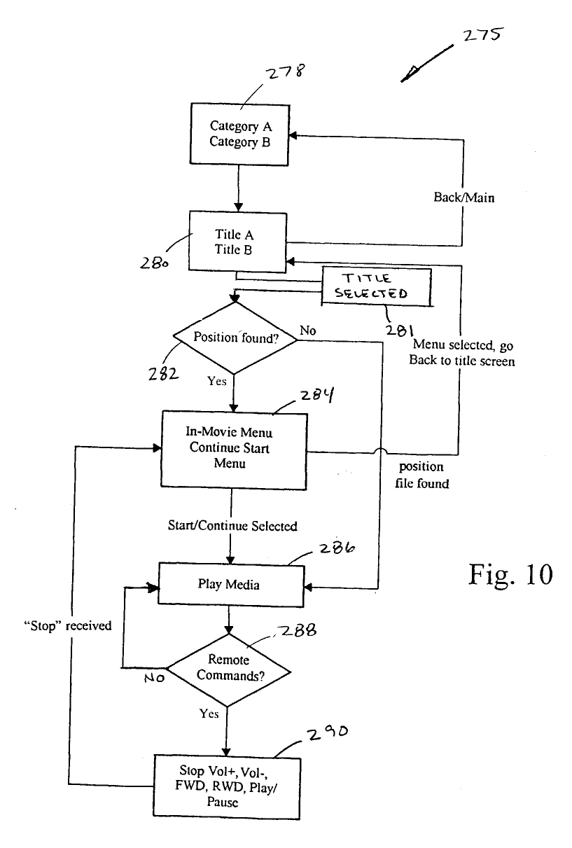

FIG. 10 illustrates a process 275 by which a user may navigate through player screen 250 of FIG. 9. At block 278, a user may select from one of a number of categories. If a category is selected, then a list of sub-categories is displayed. A user may go back to the previous level or the main level at any time through FWD/RWD buttons on the remote. At block 280, available titles of the media files may be selected. The title is selected at block 281. At block 282 a determination as to whether a previous recorded position has been found for the selected media. If the position has been found then the menu is displayed so that the user may either continue where they left off or start from the beginning, as represented by block 284. However, if the previous recorded position is not found or the user selects one of the options (continue or start) then the selected media starts playing, as represented by block 286. Remote commands are received and interpreted, at block 288. If during playback, the stop button is depressed the media file should be stopped and the screen should return to the in-movie screen, at block 284. If it is determined, at blocks 288 and 290, that during play back the volume signals are received then the volume is adjusted accordingly. If a stop signal is received then the in-movie menu is displayed. If FWD/RWD are depressed then fast forward or rewind of the media file is accomplished. If the media is playing and a play signal is received then the media is paused. If no remote commands are received at block 288 then the media continues to play as represented by block 286.

While at this screen, the user may cycle through the main button box, the back button box, and the category(title) boxes by using the fast-forward and rewind buttons on the remote 32. Further, the user may scroll up and down the list of category boxes by using the channel (±) buttons. The user may select any one of the boxes on the screen by hitting the select button on the remote 32 when the desired box on the screen is highlighted. Selecting the main button box causes the main menu (top level) to be shown on the screen. Selecting the back button box causes the system 10 to return to the previous screen. Selecting one of the category boxes causes the system 10 to load and play the selected media or proceed to the continue-start screen if a recorded position (i.e. a position where the media was previously stopped) is detected.

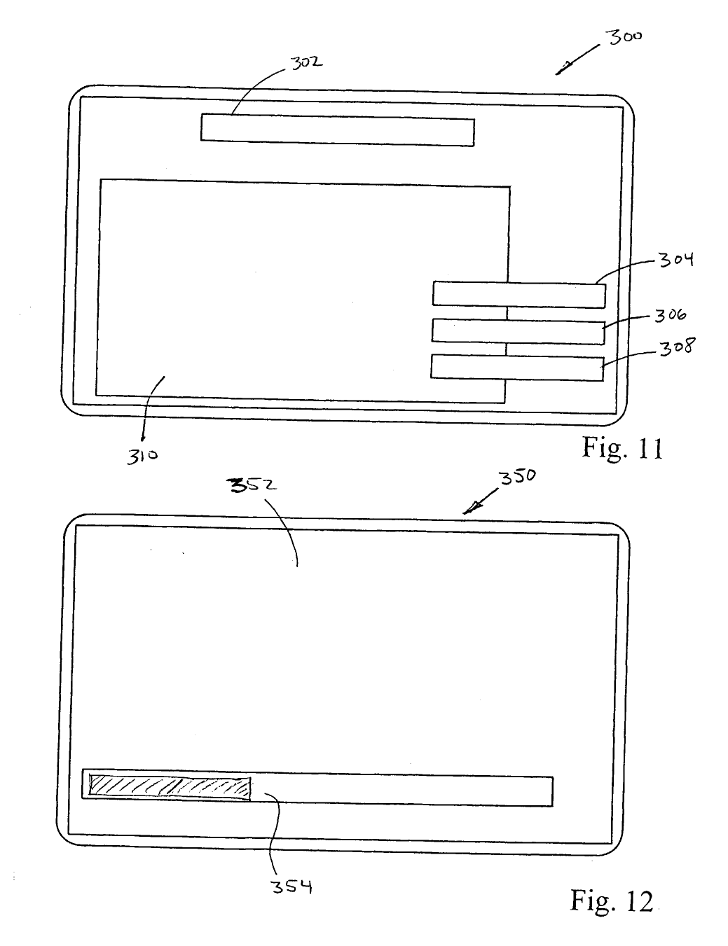

As illustrated in FIG. 11, the continue-start screen 300 includes a media title box 302, a continue box 304, a start box 306, a menu box 308, and a picture box 310. Screen 300 shows up in two instances. First, continue-start screen 300 appears when the user has selected a title from the category/title box, as discussed above, and a recorded position file exists for that title. Second, screen 300 appears when the user, during the playing of the media, presses the stop button on the remote 32. While on this screen, the channel (±) buttons on remote 32 move the selection among continue 304, start 306 and menu 308 boxes. Selecting continue box 304 causes the media to be played starting from the recorded position. Selecting the start box 306 causes the media to be played from the beginning. Selecting the menu box 308 causes system 10 to return to the category/title screen. The picture of the media title selected by the user is displayed in picture box 310.

Once the media is played, a playback screen 350, as shown in FIG. 12, will appear. The playback screen 350 shows pictures or video in a image area 352. If the media is audio only, then a wall paper may be cycled through to give the user a pleasant view while listening to the music, audio books, etc. If the media is a video file, then the actual video is displayed. A volume bar 354 is provided and, generally, hidden. Volume bar 354 shows up if the volume (±) buttons are pressed on remote 32. The volume bar 354 stays visible for 3 seconds, for example, after the volume (±) button has been pressed. While on screen 350, pressing the fast-forward and rewind buttons on the remote 32 will fast-forward and rewind the media. Pressing the play button while the media is playing will pause the media. Similarly, pressing the play button while the media is paused will cause the media to resume being played. Pressing the stop button will cause the media to stop playing and return to continue-start screen 300. Pressing the fast-forward and rewind buttons fast-forwards and rewinds the media.

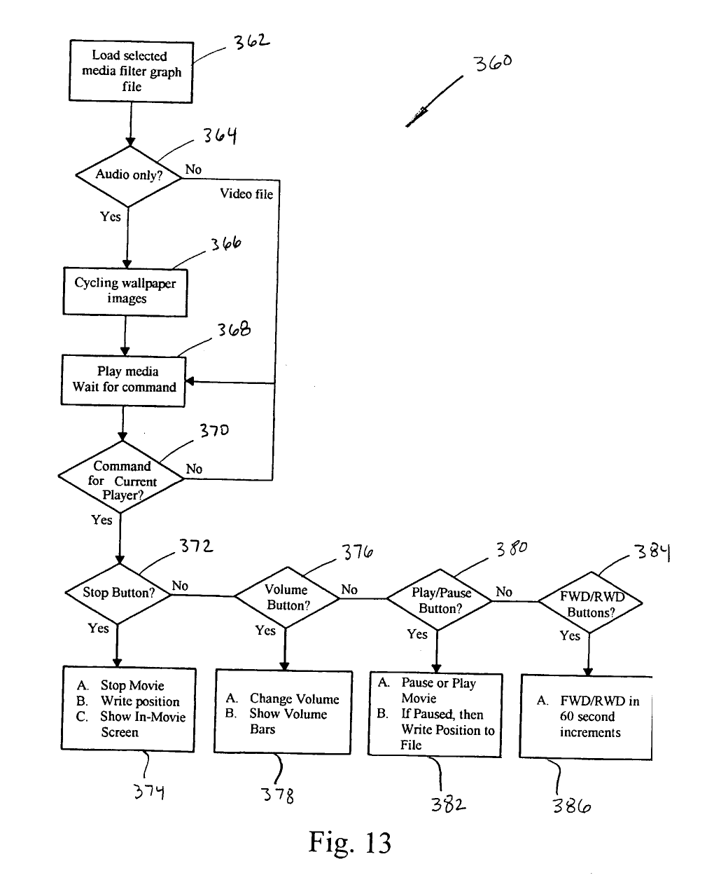

With reference to FIG. 13 a flowchart showing a process 360 by which a media file is played and the process by which system 10 responds to additional commands. At block 362, the graph file for the selected media file is loaded. A determination of whether the media file only contains audio is made, at block 364. If the media file only contains audio then, at block 366, wallpaper images are displayed and cycled through. However, if the media file contains video then, at block 368, the media file is played and the system waits for commands. At block 370, a determination of whether a command for the current player has been received.

At block 372, a determination of whether a stop button has been pressed. If, at block 372, the stop button has been pressed then each of the following tasks is performed: stop the media file, write position and show the in-movie screen, as represented by block 374. If, however, the stop button has not been pressed, at block 376, a determination is made as to whether the volume button has been pressed. If, at block 376, the volume button has been pressed then each of the following tasks is performed: the volume is changed and the volume bars are shown, as represented by block 378.

If, however, the volume button has not been pressed, at block 380, a determination is made as to whether the play/pause button has been pressed. If the play/pause button has been pressed, then at block 382 each of the following tasks is performed: the media is paused or played and if paused then the position is written to a file. If the play/pause button has not been pressed, then at block 384 a determination is made as to whether a forward/reverse buttons have been pressed. If forward/reverse buttons have been pressed then at block 386 the media is forwarded or reversed in sixty second intervals.

As any person skilled in the relevant art will recognize from the previous detailed description and from the figures, modifications and changes can be made to the preferred embodiments of the invention without departing from the scope of this invention.

We claim:

1. An entertainment system for a vehicle, the system comprising:
a storage device having entertainment media stored therein;
at least one video display device for displaying the entertainment media stored on the storage device;
at least one audio device for broadcasting audio signals stored on the storage device to an interior of the vehicle;
a distribution box in communication with the storage device, the at least one video device and the at least one audio device, for routing the entertainment media selected by a system user from the storage device to one of the at least one video device and the at least one audio device.

2. The entertainment system of claim 1 further comprising a data source having a plurality of entertainment data stored thereon, wherein the data source is in communication with the storage device.

3. The system of claim 1 wherein the storage device is a hard drive.

4. The system of claim 1 further comprising a portable storage device for storing entertainment media stored on a data source remote from the vehicle.

5. The system of claim 1 wherein the storage device stores entertainment media transmitted by a remote data source.

6. The system of claim 1 further comprising a remote control device for controlling an operation of the entertainment system.

7. The system of claim 1 wherein the distribution box further comprises a wireless receiver.

8. The system of claim 1 wherein the distribution box further comprises an audio control board.

9. The system of claim 1 wherein the distribution box further comprise a video control board.

10. The system of claim 1 wherein the distribution box is a portable storage device interface.

11. A method for entertaining multiple vehicle occupants using an vehicle entertainment system disposed in a vehicle, the method comprising:
storing an entertainment media on a storage device;
displaying the entertainment media stored on the storage device on at least two video display devices disposed within the vehicle;
broadcasting audio signals stored on the storage device to an interior of the vehicle using at least two audio devices; and
routing the entertainment media selected by a system user from the storage device to one of the video devices and the audio devices using a distribution box in communication with the storage device, the at least two video device and the at least two audio devices.

12. The method of claim 11 further comprising creating a filter graph file to separate a video stream from an audio stream of the entertainment media to allow the video stream to be routed to at least two video display devices and to at least two audio devices disposed within the vehicle.

13. The method of claim 11 wherein storing an entertainment media further comprising storing a plurality of entertainment data on the storage device.

14. The method of claim 11 further comprising transmitting entertainment media from a remote data source to the storage device.

15. The method of claim 11 further comprising storing entertainment media on a portable storage device for use in the vehicle.

16. The system of claim 11 controlling an operation of the entertainment system using a remote control device.

17. The system of claim 11 further comprising separating an audio content from a video content of the entertainment media.

18. The system of claim 11 wherein displaying the entertainment media further comprises displaying a video image while broadcasting the audio signals.
